(19) United States
(12) Patent Application Publication
(10) Pub. No.: US 2005/0165984 A1
(43) Pub. Date: Jul. 28, 2005

(54) Data management

(76) Inventors: Kenneth Seier, Medfield, MA (US); Coleen Crawford, Raynham, MA (US)

Correspondence Address: THE LAW OFFICES OF STEVEN MCHUGH, LLC, 46 WASHINGTON STREET, MIDDLETOWN, CT, 06457, US

(21) Appl. No.: 11/046,116

(22) Filed: Jan. 28, 2005

Related U.S. Application Data
(60) Provisional application No. 60/539,636, filed on Jan. 28, 2004.

(51) Int. Cl. G06F 3/00

(52) U.S. Cl. 710/52

(57) ABSTRACT

A system and method for managing data using an expandable data management scheme is provided, wherein the method includes assigning an object symbol to a subject being examined, wherein the object symbol is responsive to the subject, identifying a characteristic of the subject, assigning a condition symbol to the subject responsive to the characteristic of the subject, associating the condition symbol with the object symbol responsive to the characteristic of the subject, generating a description of the subject to correlate the condition symbol with the characteristic of the subject and generating a report responsive to the description of the subject.

### RELATED APPLICATIONS

The present application claims priority of U.S. Provisional Patent Application Ser. No. 60/539,636 filed Jan. 28, 2004, the contents of which are incorporated herein by reference in its entirety.

### FIELD OF THE INVENTION

This invention relates generally to the management of data and more particularly to a method and system for managing data using an expandable data management scheme to manage and correlate data collected during an examination.

### BACKGROUND OF THE INVENTION

In most situations involving the collection, dissemination and documentation of data, it is important that the data be collected, managed and recorded in a reliable, consistent and accurate manner so as to be as organized and unambiguous as possible. This is because any conclusions derived from this data may have far reaching consequences such as being used as a basis for legal and/or financial determinations. For example, oftentimes conclusions formed by the examination of data collected during a postmortem examination are used as support for a criminal charge, such as homicide or sexual assault. As such, because these conclusions will most likely be challenged during a court proceeding, any data that is collected and reported must be reliable, consistent and accurate enough to survive scrutiny.

A postmortem examination, or autopsy (also known as a necropsy), is a term used to describe a medical examination of a dead body that is performed under controlled conditions and that is typically conducted in order to determine the cause of death of a person and/or to study pathological changes in the tissues and/or organs of the body. Although an autopsy may be conducted for educational purposes, such as physician training and/or research to advance medical knowledge, an autopsy is typically conducted for legal reasons, such as a determination of a cause of death in a police investigation involving suspicious or unusual circumstances. Expanding on the above example, the law may require that a person who has died under violent, suspicious and/or unknown circumstances undergo an autopsy to determine whether foul play was involved in the person's death, either directly or indirectly. The results of an autopsy performed under these circumstances may then be used as an evidentiary basis for a criminal charge, such as homicide or sexual assault. Because the conclusions of a postmortem examination in a criminal case may have severe consequences, in some cases life or death consequences, each step of the autopsy must be controlled, well documented, well organized and accurate.

As the forensic pathologist performs the autopsy, each part of the body will be examined and the results of the examination will be documented. The pathologist may perform this documentation using any one of a number of methods. For example, one method may involve taking video and/or pictures of the body and/or scene and talking into a voice recording device during the postmortem procedure. Another method may involve the pathologist recording observations by taking pictures, talking into a voice recording device and taking notes with the use of an assistant. Still another method may involve the pathologist recording observations by taking pictures, talking into a voice recording device and taking notes without the use of an assistant. In each of these situations, the pathologist must then generate a forensic report using all of the data obtained as described above. To do this, the obtained information must be put into a report format including a complete written description of the body as observed during the examination. The pathologist may then use 2-dimensional paper diagrams and/or pictures to correlate the written description with the body and to illustrate the location of scars, wounds, marks or any other tissue damage and/or anomaly.

This typically produces a report format where the text is generated using software, the graphics are generated using 2-dimensional paper diagrams filled out by hand and the pictures are physically inserted into the report. As such, even though these documentation and report generation methods have been in use for a long period of time, they do not allow for accurate graphical representation and thus, do not produce an examination report having a consistent format. Additionally, because these data sources do not merge together easily, a significant amount of time may be needed to generate a complete examination report. As such, the format and accuracy of the data and figures in the examination report is typically specific to the pathologist and/or morgue performing the autopsy. Additionally, records and/or reports may have to be provided to investigators and/or prosecutors and currently these records and/or reports must be transferred physically and may comprise larges volumes of paper documents. Similarly, this is true for other areas which require reports having text and/or graphical information, such as in the case of criminal investigations, accident reconstruction, medical procedure documentation, etc. Unfortunately however, this lack of consistency may be used to call into question any conclusions drawn from the examination.

### SUMMARY OF THE INVENTION

A system and method for managing data using an expandable data management scheme is provided, wherein the method includes assigning an object symbol to a subject being examined, wherein the object symbol is responsive to the subject, identifying a characteristic of the subject, assigning a condition symbol to the subject responsive to the characteristic of the subject, associating the condition symbol with the object symbol responsive to the characteristic of the subject, generating a description of the subject to correlate the condition symbol with the characteristic of the subject and generating a report responsive to the description of the subject.

A method for implementing an expandable data management scheme is provided, wherein the method includes examining a subject of interest, gathering data responsive to examining the subject, implementing the expandable data management scheme, wherein the expandable data management scheme includes, assigning an object symbol to the subject being examined, wherein the object symbol is responsive to the subject, identifying a characteristic of the subject, assigning a condition symbol to the subject responsive to the characteristic of the subject, associating the condition symbol with the object symbol responsive to the characteristic of the subject, generating data responsive to the subject to correlate the condition symbol with the characteristic of the subject and generating a report in a manner responsive to the expandable data management scheme and the gathering data.

A system for implementing an expandable data management scheme is provided, wherein the system includes an input device, an output device, a processing device, wherein the processing device is communicated with the input device and the output device and a storage device, wherein the storage device is associated with the processing device and includes an expandable data management scheme, wherein the processing device receives input data from the input device, processes the input data responsive to the expandable data management scheme to generate output data and communicates the output data to the output device.

A medium encoded with a machine-readable computer program code is also provided wherein the program code includes instructions for causing a controller to implement a method for managing data using an expandable data management scheme, wherein the method includes examining a subject of interest, gathering data responsive to examining the subject, implementing the expandable data management scheme, wherein the expandable data management scheme includes, assigning an object symbol to the subject being examined, wherein the object symbol is responsive to the subject, identifying a characteristic of the subject, assigning a condition symbol to the subject responsive to the characteristic of the subject, associating the condition symbol with the object symbol responsive to the characteristic of the subject, generating data responsive to the subject to correlate the condition symbol with the characteristic of the subject and generating a report in a manner responsive to the expandable data management scheme and the gathering of data.

A machine-readable computer program code is also provided wherein the program code includes instructions for causing a controller to implement a method for managing data using an expandable data management scheme, wherein the method includes examining a subject of interest, gathering data responsive to examining the subject, implementing the expandable data management scheme, wherein the expandable data management scheme includes, assigning an object symbol to the subject being examined, wherein the object symbol is responsive to the subject, identifying a characteristic of the subject, assigning a condition symbol to the subject responsive to the characteristic of the subject, associating the condition symbol with the object symbol responsive to the characteristic of the subject, generating data responsive to the subject to correlate the condition symbol with the characteristic of the subject and generating a report in a manner responsive to the expandable data management scheme and the gathering of data.

### BRIEF DESCRIPTION OF THE DRAWINGS

The foregoing and other features and advantages of the present invention will be more fully understood from the following detailed description of illustrative embodiments, taken in conjunction with the accompanying drawings in which like elements are numbered alike in the several figures:

FIG. 1 is a high-level block diagram illustrating an Expandable Data Management Scheme (EDMS), in accordance with an exemplary embodiment;

FIG. 2 is a block diagram illustrating the architecture of a Standard Core Functionality Module of the Expandable Data Management Scheme of FIG. 1;

FIG. 3 is a block diagram illustrating the architecture of a Main Form Module of the Expandable Data Management Scheme of FIG. 1;

FIG. 4 is a block diagram illustrating the architecture of a Main Form Module of the Expandable Data Management Scheme of FIG. 1;

FIG. 5 is a block diagram illustrating the architecture of a Main Form Module of the Expandable Data Management Scheme of FIG. 1;

FIG. 6 is a block diagram illustrating the architecture of an Options Dialog Module of the Expandable Data Management Scheme of FIG. 1;

FIG. 7 is a block diagram illustrating the architecture of a Presentation Toolbox Module of the Expandable Data Management Scheme of FIG. 1;

FIG. 8 is a block diagram illustrating the architecture of an About Form Module and a Help Files Module of the Expandable Data Management Scheme of FIG. 1;

FIG. 9 is a block diagram illustrating the architecture of a Presentation Form Module and a Report Document List Module of the Expandable Data Management Scheme of FIG. 1;

FIG. 10 is a high-level block diagram illustrating the architecture of a Plug-In Manager of the Expandable Data Management Scheme of FIG. 1;

FIG. 11 is a high-level block diagram illustrating the architecture of a Plug-In Manager of the Expandable Data Management Scheme of FIG. 1, wherein the Expandable Data Management Scheme includes multiple PIM's;

FIG. 12 is a block diagram illustrating the architecture of a Plug-In Module of the Expandable Data Management Scheme of FIG. 1;

FIG. 13 is a block diagram illustrating the architecture of a Data File Interface Module of the Expandable Data Management Scheme of FIG. 1;

FIG. 14 is a block diagram illustrating a method for managing data using the Expandable Data Management Scheme of FIG. 1, in accordance with an exemplary embodiment;

FIG. 15 is a screen capture of a Graphical User Interface from the Expandable Data Management Scheme of FIG. 1;

FIG. 16 is a screen capture of a Graphical User Interface from the Expandable Data Management Scheme of FIG. 1 showing an object symbol representative of an adult male;

FIG. 17 is a screen capture of a Graphical User Interface from the Expandable Data Management Scheme of FIG. 1 showing an object symbol representative of an adult male;

FIG. 18 is a screen capture of a Graphical User Interface from the Expandable Data Management Scheme of FIG. 1 showing an object symbol representative of an adult male;

FIG. 19 is a screen capture of a Graphical User Interface from the Expandable Data Management Scheme of FIG. 1 showing an object symbol representative of an adult male;

FIG. 20 is a screen capture of a Graphical User Interface from the Expandable Data Management Scheme of FIG. 1 showing an object symbol representative of an adult male;

FIG. 21 is a screen capture of a Graphical User Interface from the Expandable Data Management Scheme of FIG. 1 showing an object symbol representative of a skull of an adult male;

FIG. 22 is a screen capture of a Graphical User Interface from the Expandable Data Management Scheme of FIG. 1 showing an object symbol representative of a skull of an adult male;

FIG. 23 is a screen capture of a Graphical User Interface from the Expandable Data Management Scheme of FIG. 1 showing an object symbol representative of a skull of an adult male;

FIG. 24 is a screen capture of a Graphical User Interface from the Expandable Data Management Scheme of FIG. 1 showing an object symbol representative of a skull of an adult male;

FIG. 25 is a screen capture of a Graphical User Interface from the Expandable Data Management Scheme of FIG. 1 showing an object symbol representative of a brain of an adult male;

FIG. 26 is a screen capture of a Graphical User Interface from the Expandable Data Management Scheme of FIG. 1 showing an object symbol representative of a brain of an adult male;

FIG. 27 is a screen capture of a Graphical User Interface from the Expandable Data Management Scheme of FIG. 1 showing an object symbol representative of a brain of an adult male;

FIG. 28 is a screen capture of a Graphical User Interface from the Expandable Data Management Scheme of FIG. 1 showing an object symbol representative of the internal organs of an adult male;

FIG. 29 is a block diagram illustrating a method for managing data using the Expandable Data Management Scheme of FIG. 1; and

FIG. 30 is a schematic block diagram illustrating a system for implementing a method for managing data using the Expandable Data Management Scheme of FIG. 1.

### DETAILED DESCRIPTION OF THE INVENTION

For simplicity in understanding and description, the Expandable Data Management Scheme (EDMS) will be described herein in terms of a plug in for a forensic examination. However, while a method and system for managing data using the EDMS to manage and correlate data collected during an examination is described and discussed hereinabove with reference to a postmortem examination, it should be appreciated that the method and system described herein may be applied to other types of examinations, such as medical (pre-mortem) examinations, crime scene examination/reconstruction (murder, arson, etc.) and accident reconstruction (aviation, automobile, etc).

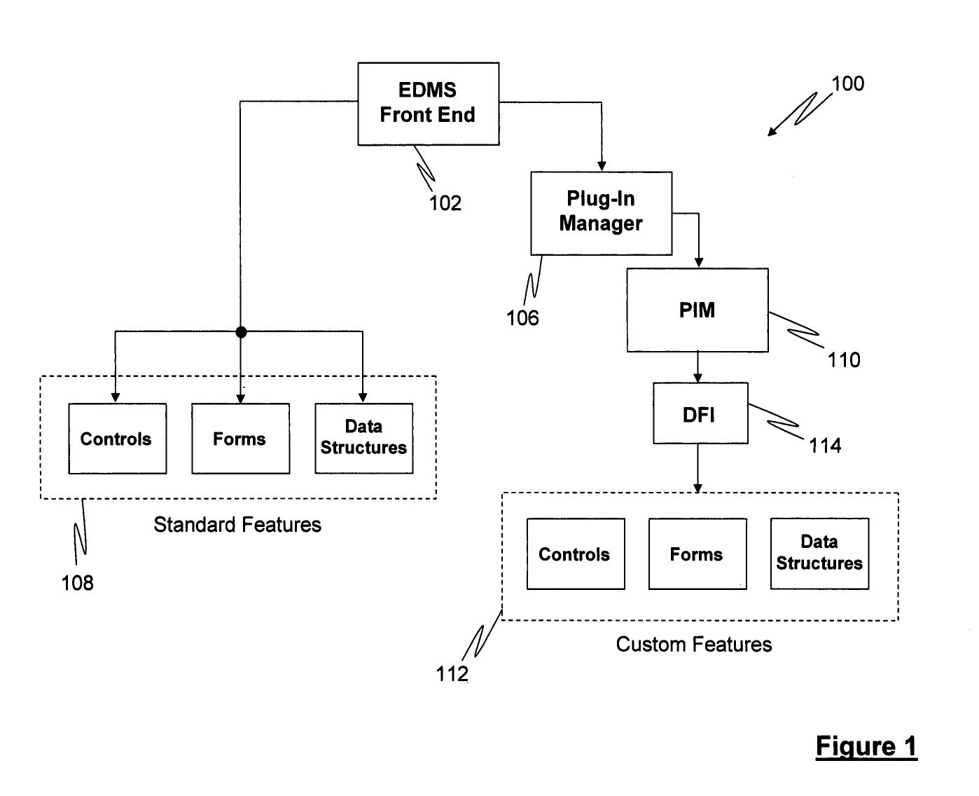

Referring to FIG. 1, a high-level block diagram illustrating an Expandable Data Management Scheme (EDMS) 100 is shown and includes an EDMS front end 102 communicated with at least one Plug-In Manager 106, wherein the EDMS front end 102 may be communicated with the at least one Plug-In Manager 106 directly (to gain direct access to the standard features) or via a Dynamic Link Library (DLL). EDMS 100 includes at least one Standard Core Functionality Module (SCFM) 108 communicated with EDMS front end 102. EDMS 100 also includes at least one Plug-In Module (PIM) 110 having at least one Custom Core Functionality Module (CCFM) 112, wherein the EDMS front-end 102 accesses CCFM 112 via a Data File Interface (DFI) 114 communicated with Plug-In Manager 106 via PIM 110. It should be appreciated that DFI 114 is used to establish a standardized interface for any and all PIMs 110 associated with EDMS front end 102. EDMS front end 102 may be a plug-in shell application constructed as a multiple document interface which allows at least one user to view and manipulate multiple parts of several files individually and/or simultaneously. As such, EDMS front end 102 may manage the at least one PIM 110 via a user assembly-level reflection method and an initialization file which maintains a functional list of operable Plug-Ins. This allows the EDMS 100 to present a set of menu and toolbar controls (i.e. user interfaces) for accessing SCF 108 and/or CCFM 112 and may be configured to accept extensions of these standard controls for custom functionality features. This also allows the EDMS 100 to present a consistent Graphical User Interface (GUI) for single and/or multiple Plug-In Modules.

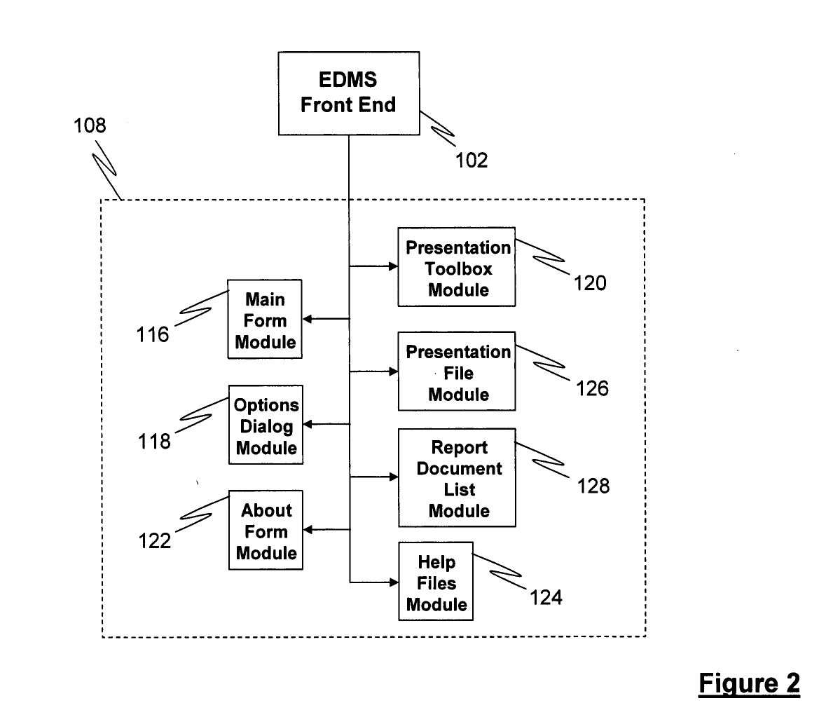

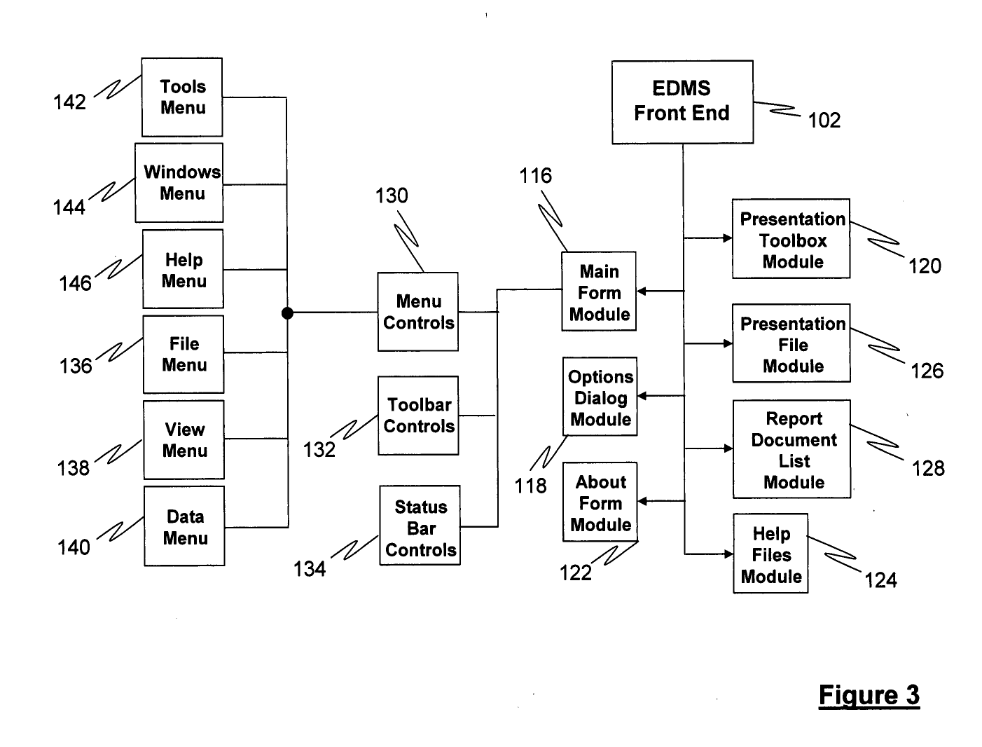

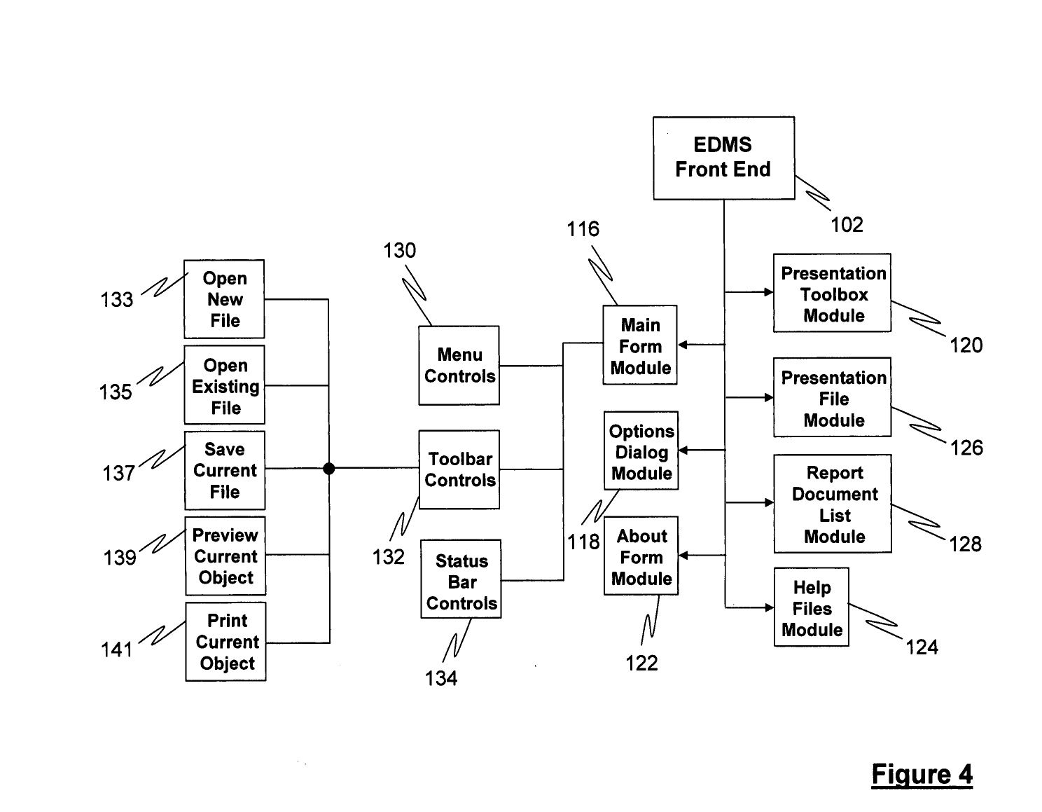

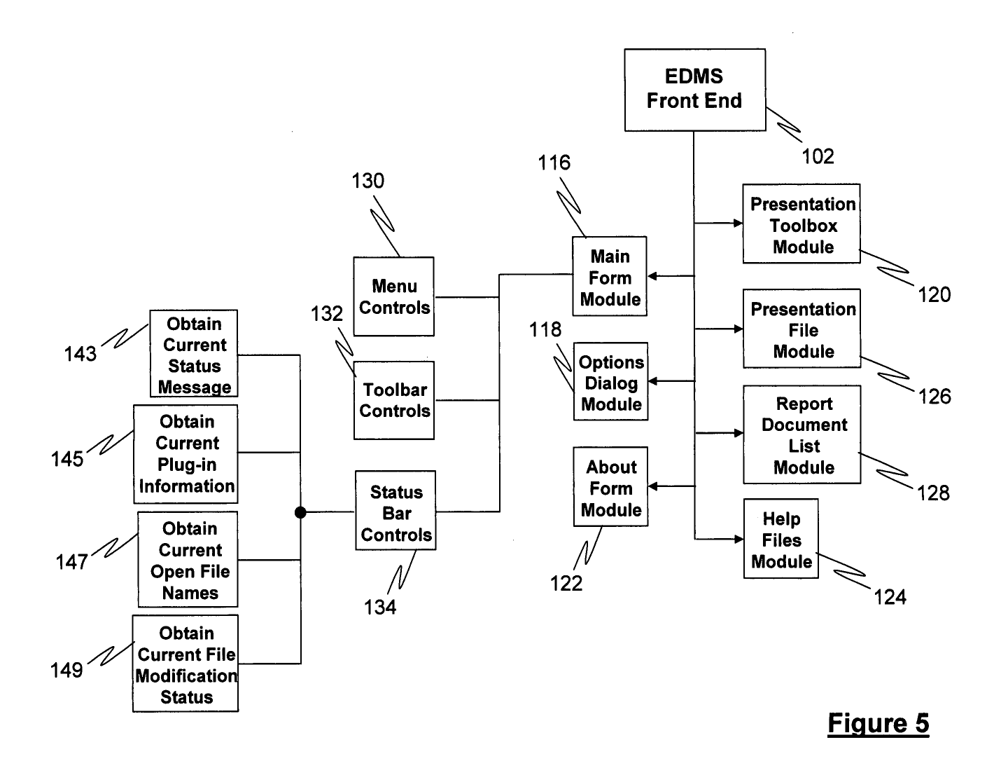

Referring to FIG. 2, a block diagram illustrating the architecture of SCFM 108 is shown and discussed. SCFM 108 includes a Main Form Module (MFM) 116, an Options Dialog Module (ODM) 118, a Presentation Toolbox Module (PTM) 120, an About Form Module (AFM) 122, a Help Files Module (HFM) 124, a Presentation File Module (PFM) 126 and a Report Document List Module (RDLM) 128. Referring to FIG. 3, FIG. 4 and FIG. 5, a block diagram illustrating MFM 116 is shown and discussed. MFM 116 controls all data and plug-ins and includes controls for the following functions: Menu Controls 130, Toolbar Controls 132 and Status Bar Controls 134. Menu Controls 130 includes code that provides a user access to several menus including, but not limited to, File Menu 136, View Menu 138, Data Menu 140, Tools Menu 142, Windows Menu 144 and Help Menu 146. File Menu 136 includes code that provides a user the capability to open a new file, open an existing file, close a current file, save a current file, save a current file to a new name/location, export a current object into a file, export a presentation file, modify print settings, preview current objects for printing, print current objects and/or exit the application.

View menu 138 includes code that provides a user the capability to show/hide file tool window and/or show/hide presentation tool window. Data Menu 140 includes code that allows a user to access specific controls in a specific PIM 110 and thus, includes capabilities which are reserved for items available from PIM 110. Tools Menu 142 includes code that allows a user to show an options dialog. Windows Menu 142 includes code that allows a user to show a list of all open child windows and Help Menu 146 includes code that allows a user to show help contents and show an about window. Toolbar Controls 132 includes code that allows a user the capability to open a new file 133, open an existing file 135, save a current file 137, print a current object 139 and/or preview a current object for printing 141. Status Bar Controls 134 includes code that allows a user the capability to obtain a current status message 143 as well as information relating to current active plug-ins 145, current open file names 147 and/or current file modification status 149.

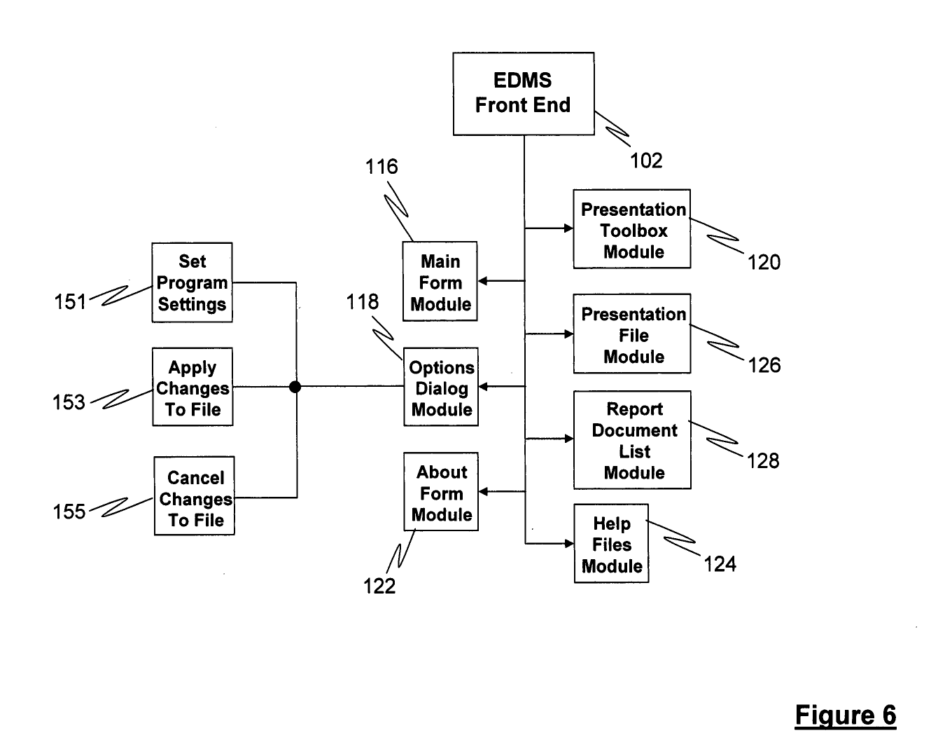

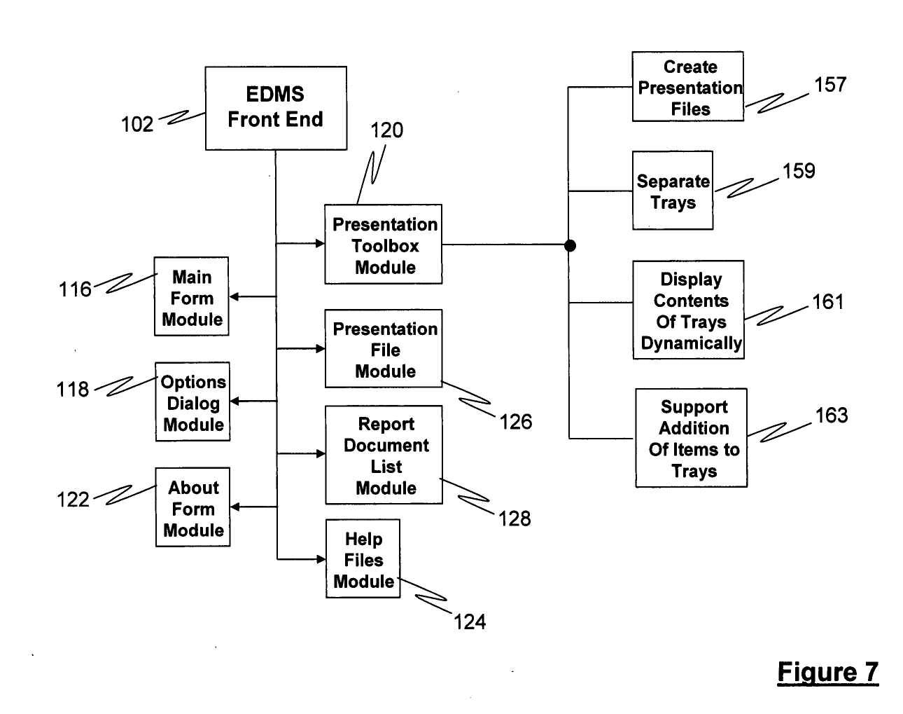

Referring to FIG. 6, a block diagram illustrating ODM 118 is shown and discussed. ODM 118 is a form that allows a user to set program settings 151 and provides a user the capability to apply 153 and/or cancel any changes made to a file 155. Referring to FIG. 7, a block diagram illustrating PTM 120 is shown and discussed. PTM 120 is a toolbox form which provides a user a toolbox for creating presentation files 157 and which allows a user to separate trays 159 for diagrams, images and reports, display contents of trays dynamically 161 and support addition of items to trays 163 by drag and drop and by context menus. Referring to FIG. 8, a block diagram illustrating AFM 122 and HFM 124 is shown and discussed. AFM 122 is a form that can be used to describe the application 165 and allows a user to display information about the current application 167, including name, version, copyright, registration, creator and installed plug-ins. HFM 124 is a form that may provide searchable information 169 to a user in web format and may be implemented as needed.

Referring to FIG. 9, a block diagram illustrating PFM 126 and RDLM 128 is shown and discussed. PFM 126 is a form that defines the standard format of all presentation files 171, wherein the presentation files include serializeable attributes. Moreover the presentation files include several properties, such as general data, CRLF data showing all data not included in other sections, diagrammatical data, Image data and Report data. RDLM 128 is a form that lists any data that was inherited 173 and allows a user to add an existing report 175 document or a new report document 177.

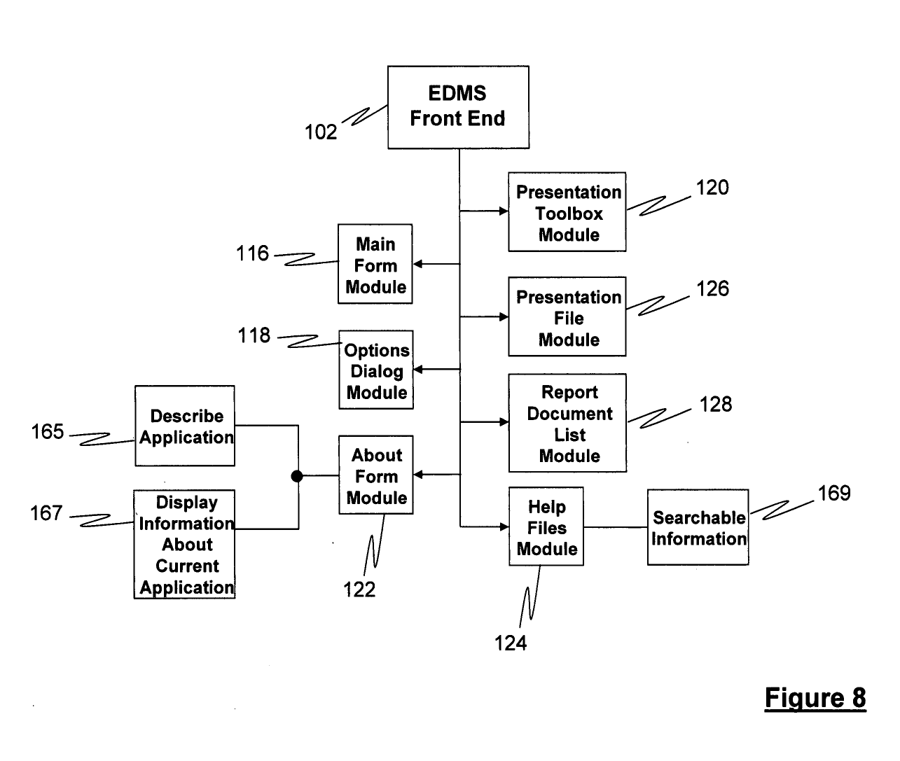

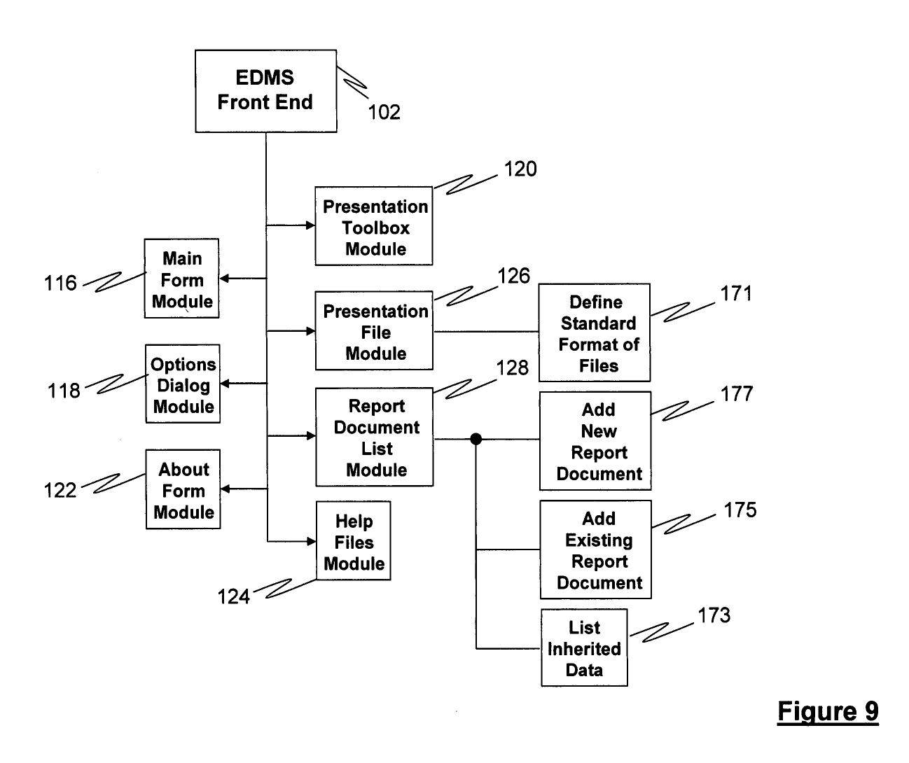

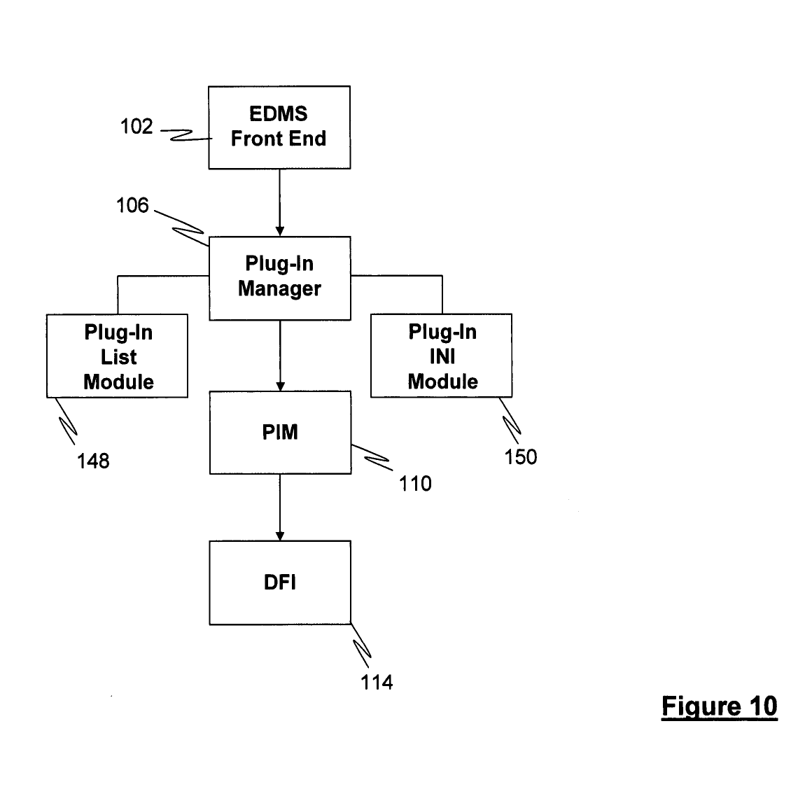

Referring to FIG. 10, a block diagram illustrating the high-level architecture of Plug-In Manager 106 is shown, wherein Plug-In Manager 106 includes a Plug-In List Module 148 and a Plug-In INI Module 150, wherein Plug-In List Module 148 maintains a sorted list of active, registered PIMs 110 and wherein Plug-In INI Module 150 generates and maintains a list of paths to registered PIMs 110. Plug-In List Module 148 includes a plurality of attributes, including Inherits, Constructors, Properties and Methods, wherein the Inherits attribute collects information on the active, registered PIMs 110 for Plug-In List Module 148, the Constructors attribute loads all of the PIMs 110 listed in the Inherits attributes, the Properties attribute allows a user to set the properties of the PIMs 110 and the Methods attribute allows a user to add a new report document and/or remove a PIM 110.

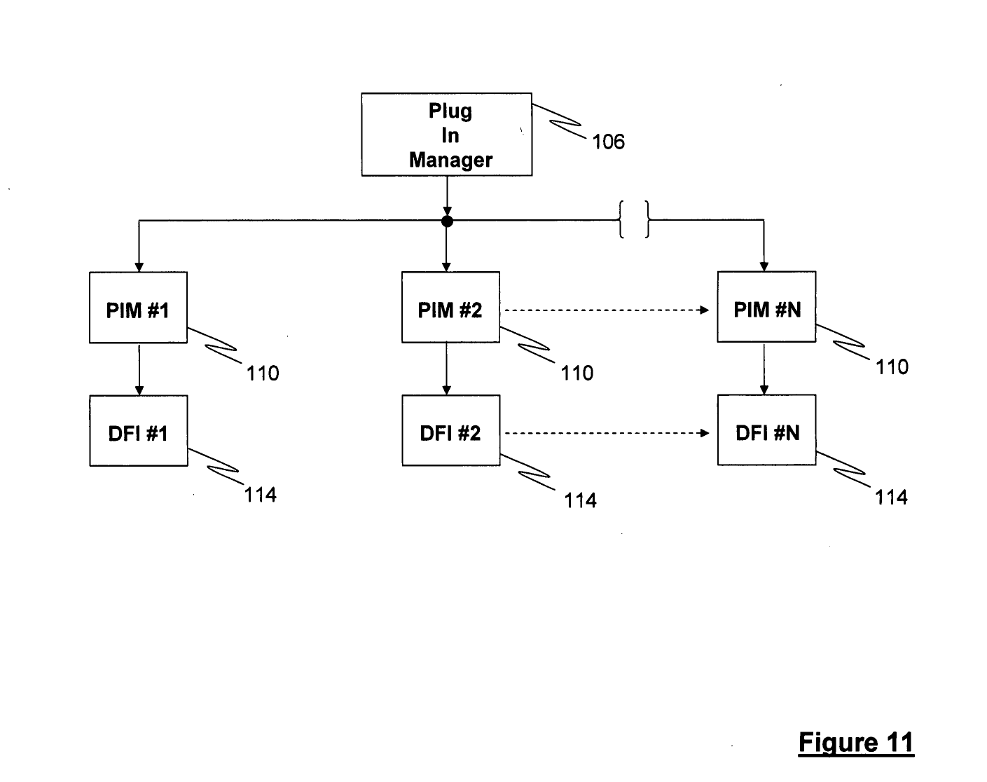

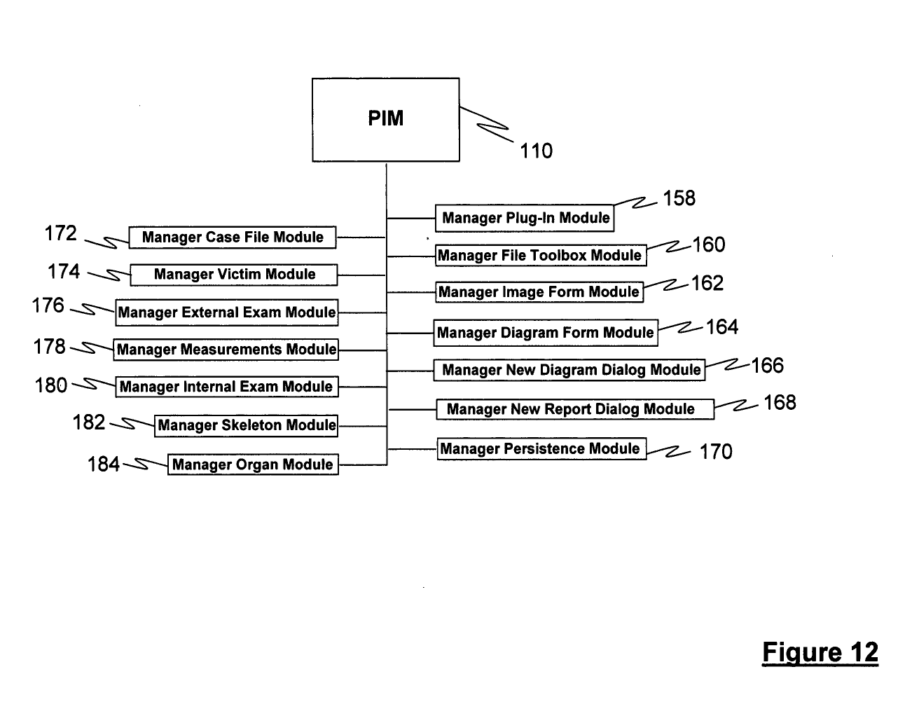

Referring to FIG. 11, a block diagram illustrating the high-level architecture of Plug-In Manager 106 having multiple PIM's 110. Although each PIM 110 is shown as including a separate Data File Interface (DFI) 114 for each PIM 110, it should be appreciated that a single and/or multiple DFI's 114 may be implemented as well. Referring to FIG. 12, a block diagram illustrating Plug-In Module 110 is shown and includes a Manager Plug-In Module 158, a Manager File Toolbox Module 160, a Manager Image Form Module 162, a Manager Diagram Form Module 164, a Manager New Diagram Dialog Module 166, a Manager New Report Dialog Module 168, a Manager Persistence Module 170, a Manager Case File Module 172, a Manager Victim Module 174, a Manager External Exam Module 176, a Manager Measurements Module 178, a Manager Internal Exam Module 180, a Manager Skeleton Module 182 and a Manager Organ Module 184.

It should be appreciated that the Manager Plug-In Module 158 manages the exposure of the custom contents of a PIM through a standardized data interface, such as a Graphical User Interface (GUI), the Manager File Toolbox Module 160 provides an interface form to create and manipulate textual data in the case file, the Manager Image Form Module 162 provides an interface form to create and manipulate image data in the case file and the Manager Diagram Form Module 164 provides an interface form to create and manipulate diagram data in the case file. Moreover, the Manager New Diagram Dialog Module 166 provides an interface form to allow a user to select specific base image(s) for a new diagram, the Manager New Report Dialog Module 168 provides an interface form to allow a user to select external/internal data for inclusion into the data, such as a specific report, a Manager Persistence Module 170 provides an interface form to allow a user to read/write case data to a storage device, such as a disk, a Manager Case File Module 172 provides an interface form to allow a user to store and manipulate all data in the case file and a Manage Victim Module 174 which provides an interface to allow a user to store and manipulate victim data.

It should also be appreciated that a Manager External Exam Module 176 is provided and allows a user note and record results of an external exam. Additionally, a Manager Measurements Module 178 is included and allows a user to store and manipulate measurements of the subject characteristics, such as heel to knee measurements, a Manager Internal Exam Module 180 provides an interface form to allow a user to store and manipulate data obtained during an internal examination, a Manager Skeleton Module 182 provides an interface form to allow a user to store and manipulate data obtained during a Skeletal examination and a Manager Organ Module 184 provides an interface form to allow a user to store and manipulate data obtained during an examination of the subjects organs. It should be appreciated that Manager Organ Module 184 includes a plurality of sub-modules for specific organs, wherein the sub-modules provide an interface form for the storage and manipulation of data obtained for that specific organ. These sub-modules include, but are not limited to, a Heart Module, a Lung Module, a Liver Module, a Spleen Module, a Kidney Module, a Stomach Module, a Uterus Module, a Neck Module, a Scalp Module, a Brain Module, a Toxicology Module and a Vitreous Module.

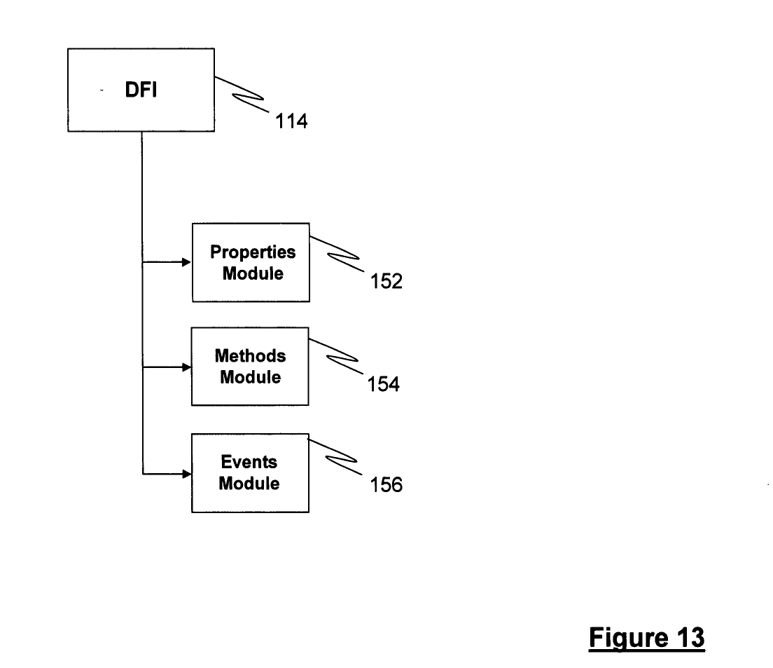

Referring to FIG. 13, a DFI 114 is shown and is used to establish a standardized interface for all PIMs 110. DFI 114 includes several attribute modules including a Properties Module 152, a Methods Module 154 and an Events Module 156. Properties Module 152 allows the user to add new menu items to the EDMS front end 102 during the loading of EDMS front end 102 and during the loading of PIM 110. The new menu items added during the loading of the PIM 110 are removed when the PIM 110 is unloaded.

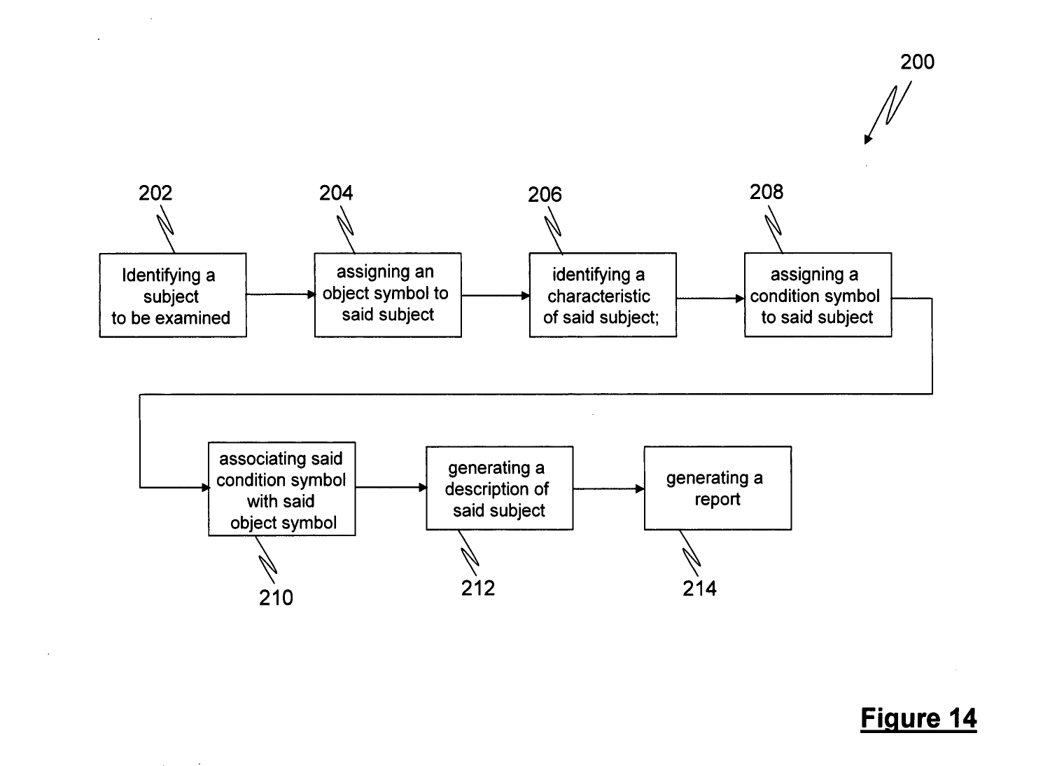

Referring to FIG. 14, a block diagram illustrating a method 200 for managing data is shown and includes identifying a subject to be examined, as shown in block 202. Using EDMS 100 Graphical User Interface (GUI) 220, an object symbol 222 is assigned to the subject, as shown in block 204, wherein the object symbol 222 may be responsive to the subject and/or the condition of the subject. For example, referring to FIG. 15, if the subject to be examined is an adult human male having a head 224, a left arm 226 and an abdomen 228, an object symbol 222 that resembles an adult human male would be assigned to the subject and the object symbol 222 would be displayed to via the GUI 220, wherein the person conducting the examination would input a known characteristic(s) about the subject, such as maturity of the subject, sex of the subject and any body measurements taken. This may be accomplished by entering the obtained data into the EDMS 100 in at least one of a predefined entrance box (for example, Body/Scene information fields 230).

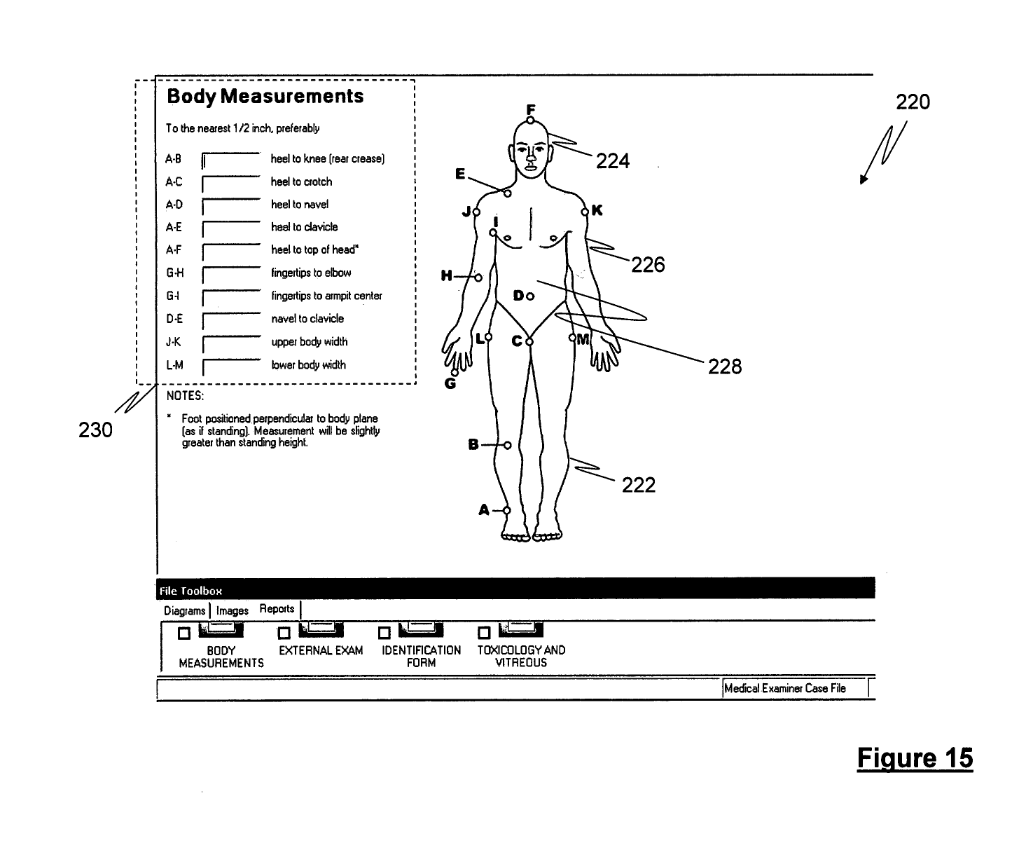

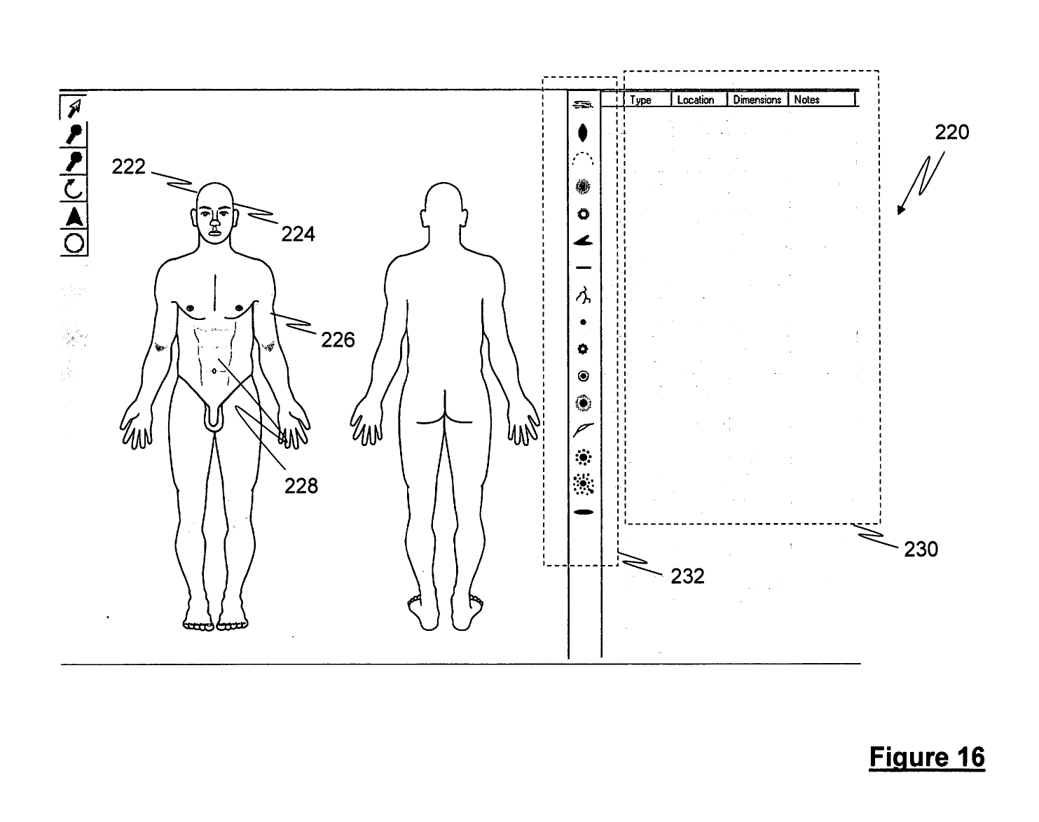

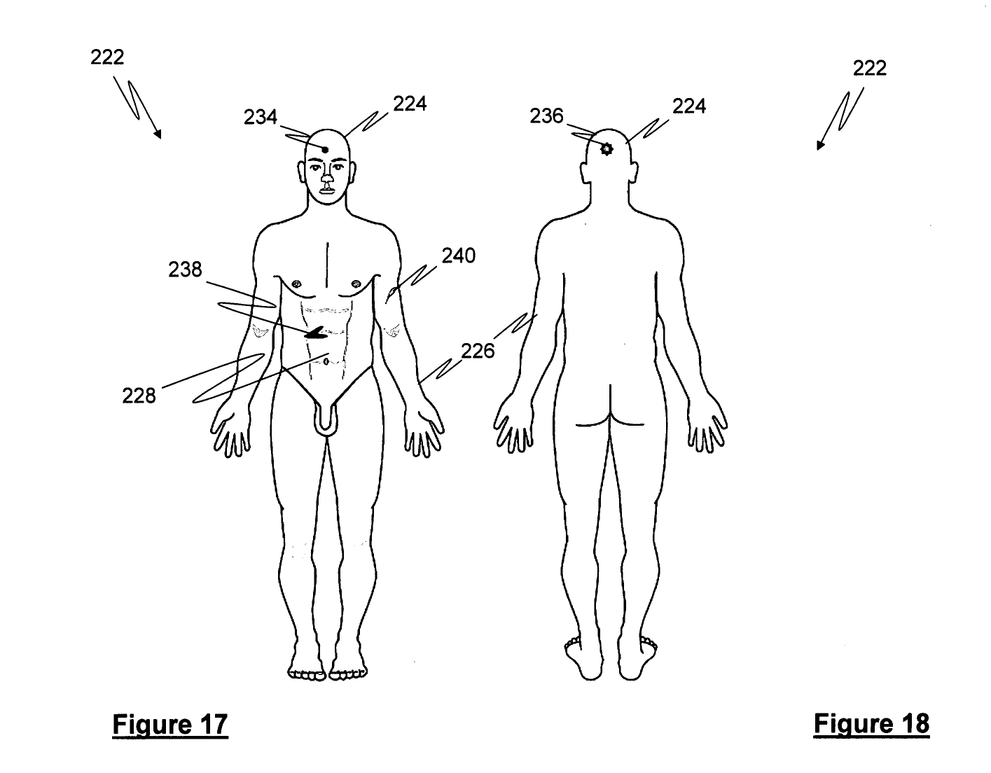

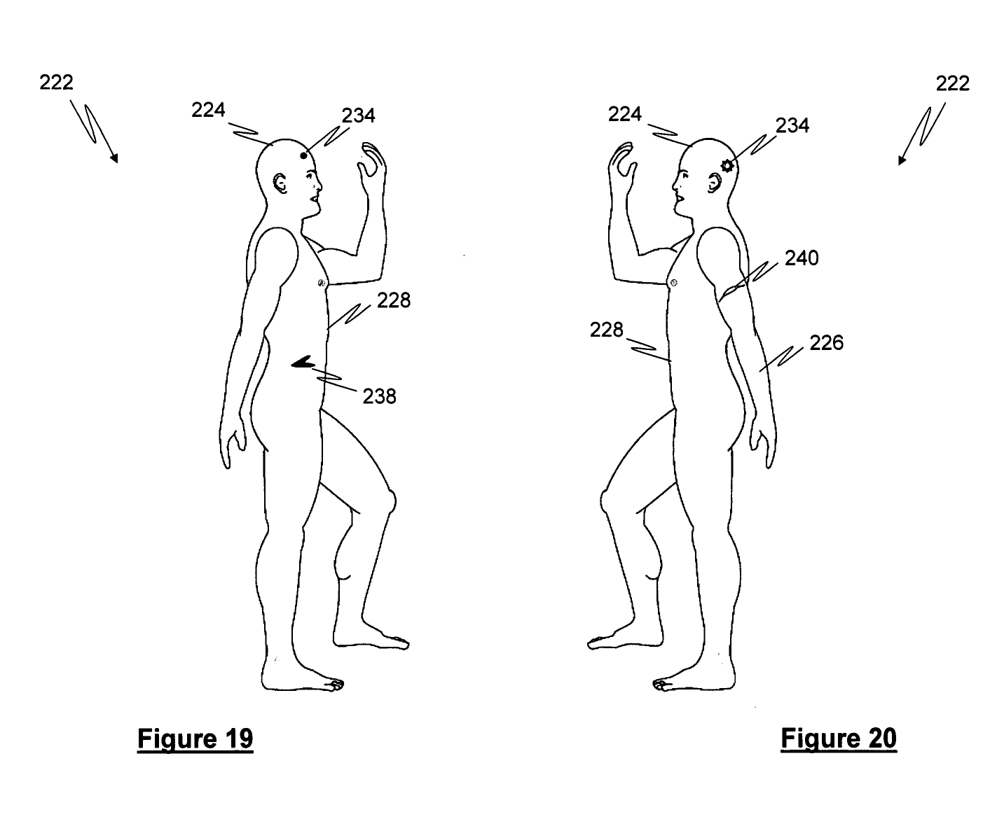

A characteristic of the subject may then be identified, as shown in block 206 and a condition symbol 232 is assigned to the subject responsive to the identified characteristic, as shown in block 208. The condition symbol 232 may then be associated with the object symbol 222 responsive to the characteristic of the subject, as shown in block 210. For example, consider the situation where a postmortem examination was being performed on an adult male who received a stab wound to the abdomen 228, a gunshot wound to the head 224 and a cut to the left arm 226. The object symbol 222 shown in FIG. 15 would be modified with predefined condition symbols 232, as shown in FIG. 16, and/or dynamically created symbols indicating the location and type of each wound. Referring to FIG. 17, FIG. 18, FIG. 19 and FIG. 20, the object symbol 222 is shown as having these wounds via a bullet entrance wound symbol 234 and a bullet exit wound symbol 236 to the head 224, a complex stab wound symbol 238 to the abdomen 228 and a laceration symbol 240 to the left arm 226. It should be appreciated that the condition symbols 232 may be shaped, sized and located for the specific wound type and location. For the less serious wounds, such as the laceration to the left arm 226, the examiner may not have to show any internal damage.

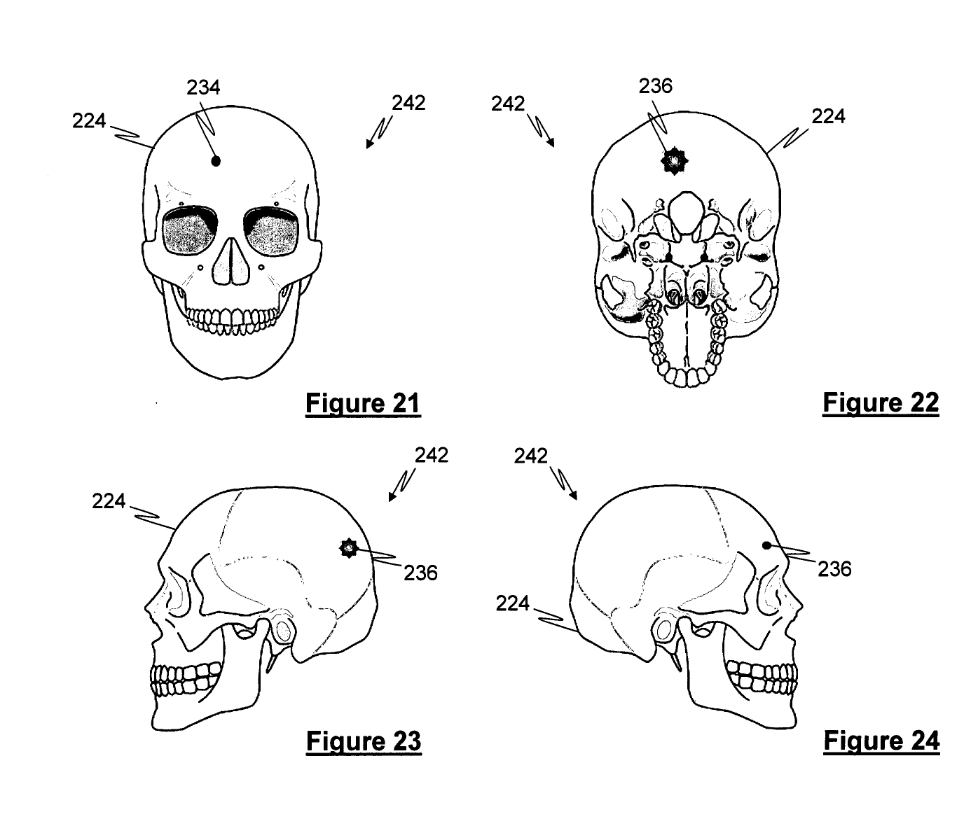

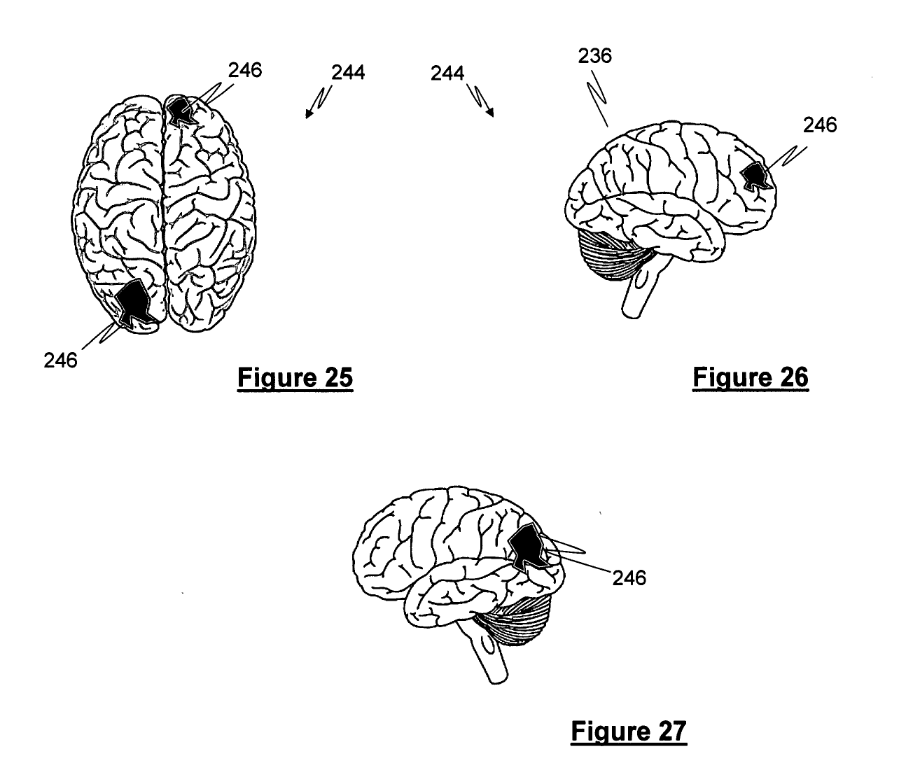

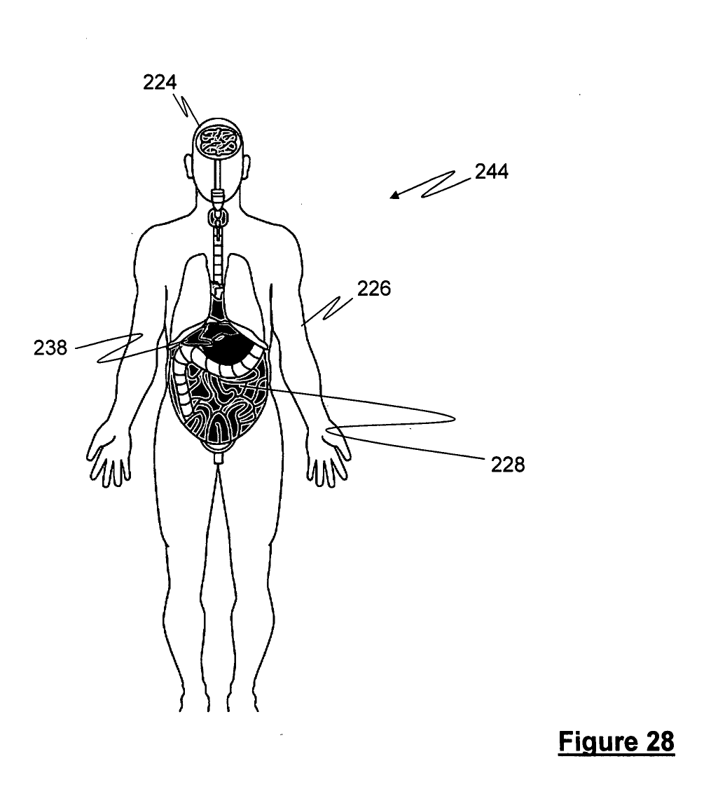

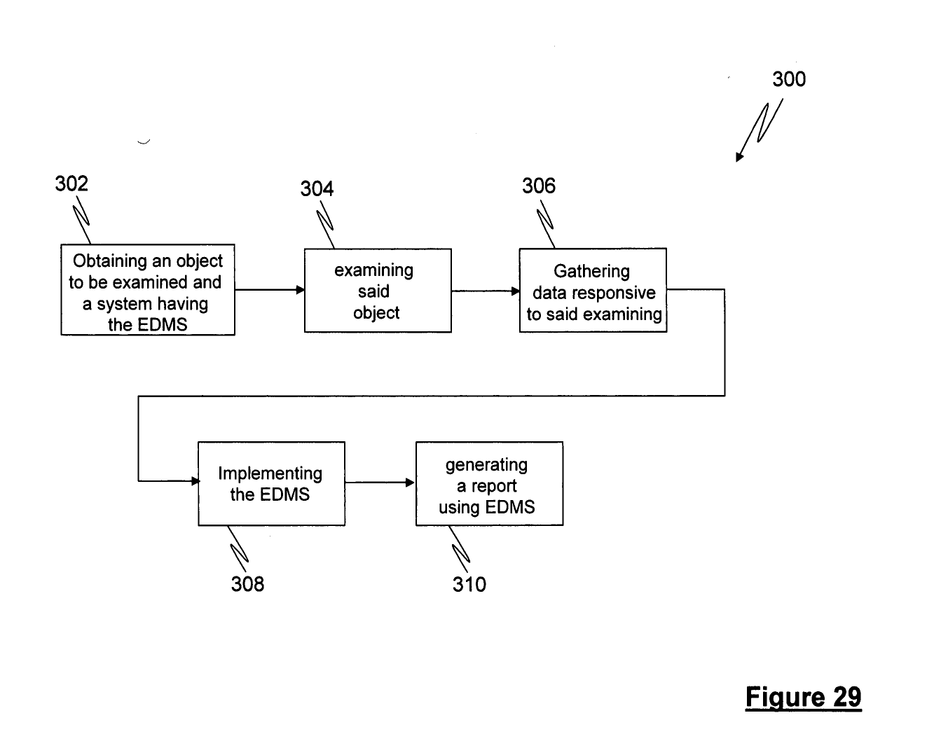

However, for the more serious wounds, such as the stab wound to the abdomen 228 and the gunshot wound to the head 224, the examiner may also want to show damage to internal organs or the skeletal system. Referring to FIGS. 20-24, an adult male skull 242 is shown, wherein the damage to the skull 242 from the gunshot wound to the head 224 is represented by the bullet entrance wound symbol 234 and the bullet exit wound symbol 236. Additionally, referring to FIG. 25, FIG. 26 and FIG. 27, damage to the brain 244 from the gunshot wound to the head 224 is shown by other trauma symbols 246. In a similar fashion, referring to FIG. 28, damage to the internal organs 248 (such as the liver 250) of the adult male from the complex stab wound to the abdomen 228 is shown via the complex stab wound symbol 238. It should be appreciated that although predefined condition symbols 232 may be used to indicate damage and/or trauma, condition symbols may also be created and defined by the user of the EDMS 100. Once all of the trauma has been identified and indicated via the GUI 220 a description of the subject may be generated to correlate the condition symbol with the characteristic of the subject, as shown in block 212 and a report may then be generated responsive to the description of the subject, as shown in block 214.

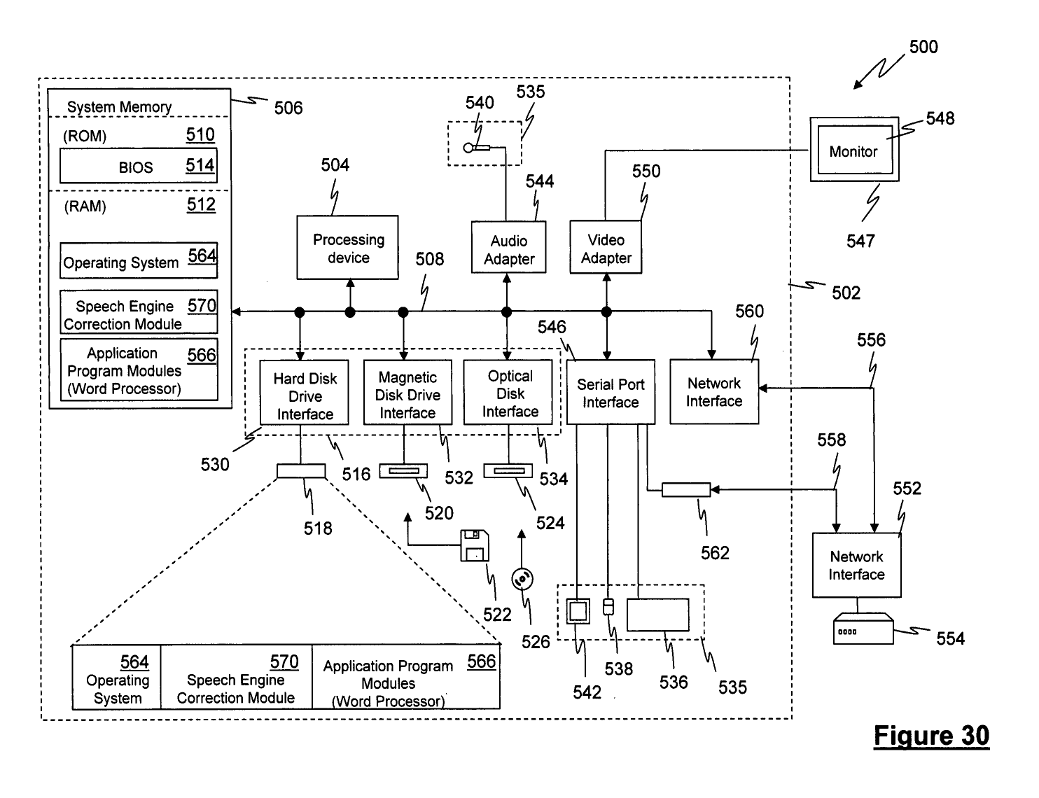

Referring to FIG. 29, a block diagram illustrating a method 300 for managing data using EDMS 100 is shown and includes obtaining an object to be examined and a system for managing data, as shown in block 302. The system includes an input device, a processing device communicated with the input device and an EDMS 100, wherein EDMS 100 is associated with the processing device to receive data from the input device and process in the data in a predetermined manner. The object is examined, as shown in block 304 and the data is gathered in response to the examination of the object, as shown in block 306. The EDMS 100 is implemented, as shown in block 308, to record, store manipulate data responsive to the examination and a report is generated responsive to EDMS 100 and the obtained data, as shown in block 310.

It should be appreciated that standard core functionality 108 may include only one standard core functionality or a plurality of standard core functionalities, including but not limited to report generation capabilities, report generation styles, image importation capabilities, data importation capabilities, menu controls and communication and data transmission capabilities, including wireless communication and data transfer capabilities. Similarly, custom core functionality 110 may include only one custom core functionality or a plurality of custom core functionalities, including but not limited to aviation and/or automobile accident documentation functionality, crime scene documentation functionality and medical examination documentation functionality. This advantageously allows EDMS front end 102 to present a consistent set of menu and toolbar controls for all plug-in modules and may accept extensions of these standard controls for custom functionalities. Moreover, although EDMS 100 may be constructed as a multiple document interface to allow a user to view and manipulate multiple parts or each file simultaneously, EDMS 100 may be constructed using any software architecture structure suitable to the desired end purpose, such as a single document interface.

Referring to FIG. 30, a block diagram illustrating a system 500 for implementing EDMS 100 is shown and includes a general computer system 502, including a processing device 504, a system memory 506, and a system bus 508, wherein the system bus 508 couples the system memory 506 to the processing device 504. The system memory 506 may include read only memory (ROM) 510 and random access memory (RAM) 512. A basic input/output system 514 (BIOS), containing basic routines that help to transfer information between elements within the general computer system 502, such as during start-up, is stored in ROM 510. The general computer system 502 further includes a storage device 516, such as a hard disk drive 518, a magnetic disk drive 520, e.g., to read from or write to a removable magnetic disk 522, and an optical disk drive 524, e.g., for reading a CD-ROM disk 526 or to read from or write to other optical media. The storage device 516 may be connected to the system bus 508 by a storage device interface, such as a hard disk drive interface 530, a magnetic disk drive interface 532 and an optical drive interface 534. The drives and their associated computer-readable media provide nonvolatile storage for the general computer system 502. Although the description of computer-readable media above refers to a hard disk, a removable magnetic disk and a CD-ROM disk, it should be appreciated that other types of media that are readable by a computer system and that are suitable to the desired end purpose may be used, such as magnetic cassettes, flash memory cards, digital video disks, Bernoulli cartridges, and the like.

A user may enter commands and information into the general computer system 502 through a conventional input device 535, including a keyboard 536, a pointing device, such as a mouse 538 and a microphone 540, wherein the microphone 540 may be used to enter audio input, such as speech, into the general computer system 502. Additionally, a user may enter graphical information, such as a drawing or hand writing, into the general computer system 502 by drawing the graphical information on a writing tablet 542 using a stylus. The general computer system 502 may also include additional input devices suitable to the desired end purpose, such as a joystick, game pad, satellite dish, scanner, or the like. The microphone 540 may be connected to the processing device 504 through an audio adapter 544 that is coupled to the system bus 508. Moreover, the other input devices are often connected to the processing device 504 through a serial port interface 546 that is coupled to the system bus 508, but may also be connected by other interfaces, such as a parallel port interface, a game port or a universal serial bus (USB).

A display device 547, such as a monitor or other type of display device 547, having a display screen 548, is also connected to the system bus 508 via an interface, such as a video adapter 550. In addition to the display screen 548, the general computer system 502 may also typically include other peripheral output devices, such as speakers and/or printers. The general computer system 502 may operate in a networked environment using logical connections to one or more remote computer systems 552. The remote computer system 552 may be a server, a router, a peer device or other common network node, and may include any or all of the elements described relative to the general computer system 502, although only a remote memory storage device 554 has been illustrated in FIG. 30. The logical connections as shown in FIG. 30 include a local area network (LAN) 556 and a wide area network (WAN) 558. Such networking environments are commonplace in offices, enterprise-wide computer networks, intranets and the Internet.

When used in a LAN networking environment, the general computer system 502 is connected to the LAN 556 through a network interface 560. When used in a WAN networking environment, the general computer system 502 typically includes a modem 562 or other means for establishing communications over a WAN 558, such as the Internet. The modem 562, which may be internal or external, may be connected to the system bus 508 via the serial port interface 546. In a networked environment, program modules depicted relative to the general computer system 502, or portions thereof, may be stored in the remote memory storage device 554. It should be appreciated that the network connections shown are exemplary and other means of establishing a communications link between the computer systems may be used. It should also be appreciated that the application module could equivalently be implemented on host or server computer systems other than general computer systems, and could equivalently be transmitted to the host computer system by means other than a CD-ROM, for example, by way of the network connection interface 560.

Furthermore, a number of program modules may be stored in the drives and RAM 512 of the general computer system 502. Program modules control how the general computer system 502 functions and interacts with the user, with I/O devices or with other computers. Program modules include routines, operating systems 564, target application program modules 566, data structures, browsers, and other software or firmware components. The method of the present invention may be included in an application module and the application module may conveniently be implemented in one or more program modules, such as a speech engine correction module 570 based upon the methods described herein. The target application program modules 566 may comprise a variety of applications used in conjunction with the present invention. These include any application and/or control having a text field, e.g. an email application, a word processor program (such as Microsoft® Word, produced by Microsoft Corporation of Redmond, Wash.), a handwriting recognition program module, the speech engine correction module 570, and an input method editor (IME).

It should be appreciated that no particular programming language is described for carrying out the various procedures described in the detailed description because it is considered that the operations, steps, and procedures described and illustrated in the accompanying drawings are sufficiently disclosed to permit one of ordinary skill in the art to practice an exemplary embodiment of the present invention. Moreover, there are many computers and operating systems that may be used in practicing an exemplary embodiment, and therefore no detailed computer program could be provided which would be applicable to all of these many different systems. Each user of a particular computer will be aware of the language and tools which are most useful for that user's needs and purposes.

In accordance with an exemplary embodiment, while a method and system for managing data using an expandable data management scheme to manage and correlate data collected during an examination is described and discussed hereinabove with reference to a postmortem examination, it should be appreciated that the method and system described herein may be applied to other types of examinations, such as medical and crime scene examinations. Moreover, although EDMS front end 102 is shown and discussed herein as a plug-in shell application, it is within the scope of the invention that EDMS front end 102 may be any type of application suitable to the desired end purpose.

A machine-readable computer program code is provided wherein the program code includes instructions for causing a controller to implement a method for managing data. The method includes obtaining a subject to be examined and assigning an object symbol to the subject, wherein the object symbol is responsive to the subject. The method further includes identifying a characteristic of the object and assigning a condition symbol to the subject in a manner responsive to the characteristic of the subject. The method also includes associating the condition symbol with the object symbol responsive to the characteristic of the subject, generating a description of the subject in order to correlate the condition symbol with the characteristic of the subject and generating a report responsive to the description of the subject.

A medium encoded with a machine-readable computer program code is also provided wherein the program code includes instructions for causing a controller to implement a method for managing data. The method includes obtaining a subject to be examined and assigning an object symbol to the subject, wherein the object symbol is responsive to the subject. The method further includes identifying a characteristic of the subject, assigning a condition symbol to the subject responsive to the characteristic of the subject and associating the condition symbol with the object symbol responsive to the characteristic of the subject. The method also includes generating a description of the subject in order to correlate the condition symbol with the characteristic of the subject and generating a report responsive to the description of the subject.

In accordance with an exemplary embodiment, the processing of FIG. 14 and FIG. 29 may be implemented by a controller disposed internal, external or internally and externally to system 500. In addition, processing of FIG. 14 and FIG. 29 may be implemented through a controller operating in response to a computer program. In order to perform the prescribed functions and desired processing, as well as the computations therefore (e.g. execution control algorithm(s), the control processes prescribed herein, and the like), the controller may includes, but not be limited to, a processor(s), computer(s), memory, storage, register(s), timing, interrupt(s), communication interface(s), and input/output signal interface(s), as well as combination comprising at least one of the foregoing. Additionally, it should be appreciated that the processing of FIG. 14 and FIG. 29 may be implemented, either partially or completely, via a standalone device, such as a desktop and/or notebook computer or a handheld device, such as a Pocket PC and/or a PDA.

The invention may be embodied in the form of a computer or controller implemented processes. The invention may also be embodied in the form of computer program code containing instructions embodied in tangible media, such as floppy diskettes, CD-ROMs, hard drives, and/or any other computer-readable medium, wherein when the computer program code is loaded into and executed by a computer or controller, the computer or controller becomes an apparatus for practicing the invention. The invention can also be embodied in the form of computer program code, for example, whether stored in a storage medium, loaded into and/or executed by a computer or controller, or transmitted over some transmission medium, such as over electrical wiring or cabling, through fiber optics, or via electromagnetic radiation, wherein when the computer program code is loaded into and executed by a computer or a controller, the computer or controller becomes an apparatus for practicing the invention. When implemented on a general-purpose microprocessor the computer program code segments may configure the microprocessor to create specific logic circuits.

While the disclosed embodiment has been described with reference to an exemplary embodiment, it should be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed herein contemplated for carrying out this invention, but that the invention will include all embodiments falling within the scope of the appended sections, such as postmortem examinations, forensic examinations, crime scene examinations, medical examinations, etc.

1. A method for managing data using an expandable data management scheme, the method comprising:
assigning an object symbol to a subject being examined, wherein said object symbol is responsive to said subject;
identifying a characteristic of said subject;
assigning a condition symbol to said subject responsive to said characteristic of said subject;
associating said condition symbol with said object symbol responsive to said characteristic of said subject;
generating a description of said subject to correlate said condition symbol with said characteristic of said subject; and
generating a report responsive to said description of said subject.

2. The method of claim 1, wherein said subject is a corpse and said at least one situation is an autopsy.

3. The method of claim 1, wherein said subject includes at least one of a person, a corpse, a cadaver, an accident scene and a crime scene.

4. The method of claim 1, wherein said at least one situation includes at least one of a medical examination, a crime scene examination, an accident scene examination and an educational examination.

5. The method of claim 1, wherein said identifying includes choosing a characteristic based on a predetermined factor, wherein said predetermined factor is responsive to at least one of an examiner and said subject.

6. The method of claim 1, wherein said characteristic of said subject is selected responsive to at least one of said subject and said at least one situation.

7. The method of claim 1, wherein said assigning a condition symbol to said subject includes assigning said condition symbol using the expandable data management scheme.

8. The method of claim 1, wherein said associating said condition symbol with said object symbol includes associating said condition symbol with said object symbol using the expandable data management scheme.

9. The method of claim 1, wherein said object symbol includes a graphical representation of an injury.

10. The method of claim 1, wherein said description of said subject includes at least one of a description of an examination process, a description of a condition of said subject, and conclusions reached on predetermined questions developed in response to said subject.

11. The method of claim 1, wherein said generating a description of said subject includes generating said description via an electronic device responsive to an expandable data management scheme.

12. The method of claim 1, wherein said generating a description of said subject includes generating images responsive to said description of said subject.

13. A method for implementing an expandable data management scheme, the method comprising:
examining a subject of interest;
gathering data responsive to said examining said subject;
implementing the expandable data management scheme, wherein the expandable data management scheme includes,
assigning an object symbol to said subject being examined, wherein said object symbol is responsive to said subject;
identifying a characteristic of said subject;
assigning a condition symbol to said subject responsive to said characteristic of said subject;
associating said condition symbol with said object symbol responsive to said characteristic of said subject;
generating data responsive to said subject to correlate said condition symbol with said characteristic of said subject; and
generating a report in a manner responsive to the expandable data management scheme and said gathering data.

14. The method of claim 13, wherein said subject is a corpse and said at least one situation is an autopsy.

15. The method of claim 13, wherein said subject includes at least one of a person, a corpse, a cadaver, an accident scene and a crime scene.

16. The method of claim 13, wherein said at least one situation includes at least one of a medical examination, a crime scene examination, an accident scene examination and an educational examination.

17. The method of claim 13, wherein said identifying includes choosing a characteristic based on a predetermined factor, wherein said predetermined factor is responsive to at least one of an examiner and said subject.

18. The method of claim 13, wherein said characteristic of said subject is selected responsive to at least one of said subject and said at least one situation.

19. The method of claim 13, wherein said assigning a condition symbol to said subject includes assigning said condition symbol using an expandable data management scheme.

20. The method of claim 13, wherein said associating said condition symbol with said object symbol using an expandable data management scheme.

21. The method of claim 13, wherein said object symbol includes a graphical representation of an injury.

22. The method of claim 13, wherein said description of said subject includes at least one of a description of an examination process, a description of a condition of said subject, and conclusions reached on predetermined questions developed in response to said subject.

23. The method of claim 13, wherein said generating a description of said subject includes generating said description via an electronic device responsive to an expandable data management scheme.

24. The method of claim 13, wherein said generating a description of said subject includes generating images responsive to said description of said subject.

25. A system for implementing an expandable data management scheme, the system comprising:
an input device;
an output device;
a processing device, wherein said processing device is communicated with said input device and said output device; and
a storage device, wherein said storage device is associated with said processing device and includes an expandable data management scheme, wherein said processing device receives input data from said input device, processes said input data responsive to said expandable data management scheme to generate output data and communicates said output data to said output device.

26. A machine-readable computer program code, the program code including instructions for causing a controller to implement a method for managing data using an expandable data management scheme, the method comprising:
examining a subject of interest;
gathering data responsive to said examining said subject;
implementing the expandable data management scheme, wherein the expandable data management scheme includes,
assigning an object symbol to said subject being examined, wherein said object symbol is responsive to said subject;
identifying a characteristic of said subject;
assigning a condition symbol to said subject responsive to said characteristic of said subject;
associating said condition symbol with said object symbol responsive to said characteristic of said subject;
generating data responsive to said subject to correlate said condition symbol with said characteristic of said subject; and
generating a report in a manner responsive to the expandable data management scheme and said gathering data.

27. The machine-readable computer program code of claim 26, wherein the machine-readable computer program code is encoded onto a storage medium.
